(19) United States
(12) Patent Application Publication
(10) Pub. No.: US 2024/0149452 A1
(43) Pub. Date: May 9, 2024

(54) INFORMATION PROCESSING SYSTEM, INFORMATION PROCESSING METHOD, AND INFORMATION PROCESSING DEVICE

(71) Applicant: SONY GROUP CORPORATION, TOKYO (JP)

(72) Inventors: ITARU SHIMIZU, TOKYO (JP); YOSHIYUKI KOBAYASHI, TOKYO (JP); SUGURU AOKI, TOKYO (JP); TOMOMITSU HERAI, TOKYO (JP)

(21) Appl. No.: 18/549,317

(22) PCT Filed: Jan. 19, 2022
(86) PCT No.: PCT/JP2022/001719

§ 371 Date: Sep. 6, 2023

(30) Foreign Application Priority Data
Mar. 17, 2021 (JP) 2021-043148

(51) Int. Cl. B25J 9/16; B25J 11/00

(52) U.S. Cl. CPC B25J 9/1666; B25J 9/163; B25J 11/0005

(57) ABSTRACT

The present disclosure relates to an information processing system, an information processing method, and an information processing device that make it possible to perform learning adaptively to changes in an external environment and circumstances. A learning section learns results of action selection made by a system in response to input information. An input information assessment section assesses a risk of the input information to the system. A first parameter calculation section calculates a first parameter representing stress on the system according to an assessed value of the input information. The learning section changes learning efficiency according to the first parameter. The technology according to the present disclosure is applicable, for example, to an information processing system that performs machine learning.

### TECHNICAL FIELD

The present disclosure relates to an information processing system, an information processing method, and an information processing device, and more particularly relates to an information processing system, an information processing method, and an information processing device that make it possible to perform learning adaptively to changes in an external environment and circumstances.

### BACKGROUND ART

In recent years, machine learning is used as a process of causing an information processing device, such as a robot or an agent, to perform optimal data processing or provide autonomous control. As a type of such machine learning, reinforcement learning is performed to learn measures for receiving maximum rewards by interacting with a situation.

Disclosed in PTL 1 is an information processing device that performs efficient reinforcement learning by using a user-inputted annotation as a reward.

### CITATION LIST

### Patent Literature

### [PTL 1]

Japanese Patent Laid-open No. 2018-64759

### SUMMARY

### Technical Problem

In some cases of machine learning, an action is not taken in a planned manner or a received reward is lower than expected. These results may be probably caused by changes in the external environment or by wrong learning in the past.

The present disclosure has been made in view of the above problem and is intended to perform learning adaptively to changes in the external environment and circumstances.

### Solution to Problem

An information processing system according to the present disclosure includes a learning section that learns results of action selection made by a system in response to input information, an input information assessment section that assesses a risk of the input information to the system, and a first parameter calculation section that calculates a first parameter representing stress on the system, according to an assessed value of the input information, in which the learning section changes learning efficiency according to the first parameter.

An information processing method according to the present disclosure is adopted by an information processing system, the information processing method including learning results of action selection made by a system in response to input information, assessing a risk of the input information to the system, calculating a first parameter representing stress on the system according to an assessed value of the input information, and changing learning efficiency according to the first parameter.

An information processing device according to the present disclosure includes a learning section that learns results of action selection made by a system in response to input information, an input information assessment section that assesses a risk of the input information to the system, and a first parameter calculation section that calculates a first parameter representing stress on the system, according to an assessed value of the input information, in which the learning section changes learning efficiency according to the first parameter.

The present disclosure learns the result of action selection made by a system in response to input information, assesses the risk of the input information to the system, calculates a first parameter representing stress on the system according to an assessed value of the input information, and changes learning efficiency according to the first parameter.

### BRIEF DESCRIPTION OF DRAWINGS

FIG. 1 is a diagram illustrating human stress response in brain science.

FIG. 2 is a block diagram illustrating an example of a configuration of an information processing system.

FIG. 3 is a block diagram illustrating an example of a functional configuration of the information processing system.

FIG. 4 is a flowchart illustrating the flow of a learning process.

FIG. 5 is a flowchart illustrating the flow of an input information assessment process.

FIG. 6 is a diagram illustrating an example of a time series of cortisol levels.

FIG. 7 is a diagram illustrating a relation between cortisol level and hippocampal volume.

FIG. 8 is a diagram illustrating an example of a learning period based on cortisol levels.

FIG. 9 is a diagram illustrating a relation between cortisol level and learning efficiency.

FIG. 10 is a diagram illustrating an example of learning efficiency with respect to cortisol level and hippocampal volume.

FIG. 11 is a block diagram illustrating an example of a configuration of a computer.

### DESCRIPTION OF EMBODIMENT

An embodiment for implementing the present disclosure (hereinafter referred to as the embodiment) will now be described. It should be noted that the description will be given in the following order.
1. Human Stress Response in Brain Science
2. Configuration of Information Processing System
3. Flow of Learning Process
4. Application Examples
5. Computer Configuration Example

### 1. HUMAN STRESS RESPONSE IN BRAIN SCIENCE

In some cases of machine learning, an action is not taken in a planned manner or a received reward is lower than expected. These results may be probably caused by changes in an external environment or by wrong learning in the past.

Further, humans feel stressed in the case where an action is not taken in a planned manner or a received reward is lower than expected.

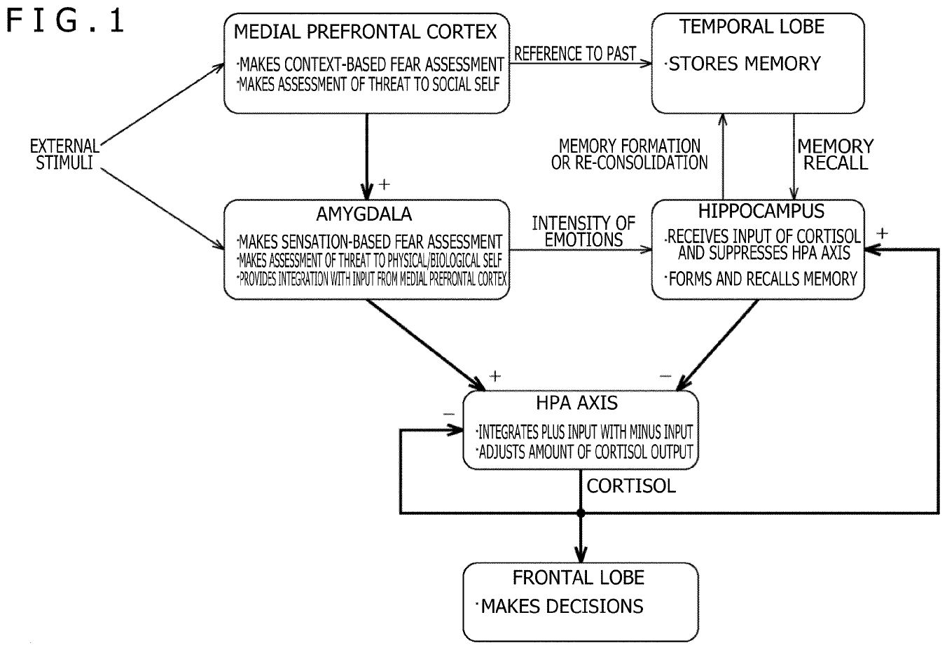

FIG. 1 is a diagram illustrating human stress response in brain science.

External stimuli received as stress from society and environment affect a medial prefrontal cortex in a frontal lobe of a brain. In response to external stimuli, the medial prefrontal cortex performs context-based fear assessment and makes an assessment of threat to social self. More specifically, for example, the medial prefrontal cortex provides error monitoring and control of self-performed actions and refers to a temporal lobe for a history of past actions. The temporal lobe is a region of the brain that provides memory storage.

An amygdala is one of limbic system regions and controlled by the medial prefrontal cortex. The amygdala performs external stimuli sensation-based fear assessment and makes an assessment of threat to physical/biological self. Further, the amygdala integrates information processed by the amygdala with an input from the medial prefrontal cortex. When activated, the amygdala activates a hypothalamic-pituitary-adrenal axis (HPA axis) in order to secrete cortisol, which is a stress hormone. Stated differently, the amygdala triggers a stress response such as anxiety and fear.

Furthermore, the amygdala, which governs emotions, affects the hippocampus, which is one of the limbic system regions and governs memory. Upon receiving the input of cortisol secreted from the HPA axis, the hippocampus suppresses the HPA axis. That is, the hippocampus has a negative feedback function for suppressing secretion of cortisol from the HPA axis.

The HPA axis adjusts an amount of cortisol output (the amount of cortisol secretion) by integrating the activation by the amygdala (a plus input) with the suppression by the hippocampus (a minus input). Further, the HPA axis has a feedback function for making adjustments to avoid excessive cortisol secretion from the HPA axis.

It is known that, because of the above-described functions, the amount of cortisol secretion (hereinafter referred to as the cortisol level) increases with a slight delay after application of psychological stress load, and gradually decreases to the previous level after removal of the psychological stress load.

However, the cortisol level increases or decreases depending on social stress or encountered circumstances. For example, in public speech or cognitive task performance, the cortisol level greatly increases. Further, in a case where a social assessment is made under self-uncontrollable circumstances, the cortisol level slightly decreases.

The cortisol secreted from the HPA axis acts on the frontal lobe, which makes decisions. The frontal lobe, which usually governs cognition and reason, makes decisions so as to suppress the secretion of cortisol. However, it is known that assessment is made so as to avoid risks when the cortisol is secreted for a long period of time, and that the most recent reward is selected when the cortisol level rapidly increases.

As described above, the secretion of cortisol dynamically affects decision-making such as risk assessment and reward prediction.

Further, the hippocampus governs memory formation and recall. More specifically, the hippocampus forms or re-consolidates a memory that is to be stored in the temporal lobe. Moreover, the hippocampus recalls a memory stored in the temporal lobe. functions of the hippocampus enable humans to learn and remember.

Meanwhile, the cortisol secreted from the HPA axis decreases the volume of the hippocampus according to the amount and time of input to the hippocampus. This results in decreasing the cortisol suppression level of the hippocampus.

For example, when some stress is applied, the nervous system is activated to improve learning and memory efficiency. However, when the intensity and duration of stress increase, the nervous system becomes less active or damaged. Further, mild stress improves the function of the hippocampus, whereas undue stress reduces the function of the hippocampus or damages the hippocampus.

As described above, moderate stress improves the functions of the nervous system and hippocampus, and thus encourages the improvement of learning ability. However, undue stress damages the nervous system and the hippocampus.

Due to the brain mechanism described above, humans are able to perform learning adaptively to changes in the external environment and circumstances in response to a situation (stress) where an action is not taken in a planned manner or a received reward is lower than expected.

The technology according to the present disclosure implements the ability to perform learning adaptively to changes in the external environment and circumstances in the course of machine learning in response to the situation (stress) where an action is not taken in a planned manner or a received reward is lower than expected.

### 2. CONFIGURATION OF INFORMATION PROCESSING SYSTEM

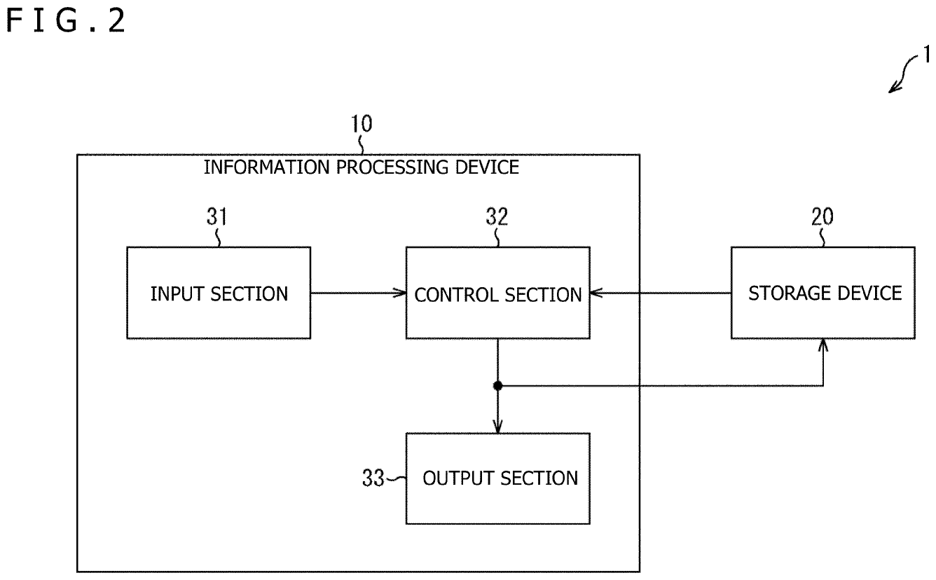

FIG. 2 is a block diagram illustrating an example configuration of an information processing system according to an embodiment of the present disclosure.

The information processing system 1 depicted in FIG. 2, which is configured, for example, as a robot or an agent, includes an information processing device 10 and a storage device 20.

The information processing device 10 is configured as a computer such as a PC (Personal Computer) performing machine learning.

The storage device 20 is configured as a semiconductor memory, a magnetic storage device, an optical storage device, or the like. The storage device 20 may be built in or detachably mounted in the information processing device 10 or may be connected to the information processing device 10 through a network such as the Internet. The storage device 20 stores the results of machine learning performed by the information processing device 10 (learning results).

The information processing device 10 includes an input section 31, a control section 32, and an output section 33.

The input section 31 includes sensors, keys, a touch panel, and an external interface. The sensors are able to acquire sensor information such as an image, a sound, a temperature, a pressure, and tactile sensation. The keys and the touch panel are able to input text information. The external interface is able to input external information from external devices and services. Various input information inputted to the input section 31 is supplied to the control section 32.

The control section 32 includes a processor such as a CPU (Central Processing Unit), and controls various sections of the information processing device 10. The control section 32 performs machine learning according to the input information from the input section 31 and the learning results stored in the storage device 20. The results of machine learning (learning results) are not only supplied to the output section 33 but also stored in the storage device 20.

The output section 33 is configured, for example, as a display capable of displaying an image and a text, a speaker capable of outputting a sound, or a light-emitting section for emitting light. In a case where the information processing device 10 is configured as an autonomous mobile robot or agent, the output section 33 is configured as a drive mechanism for moving the information processing device 10.

Alternatively, the information processing system 1 depicted in FIG. 2 may be configured such that, for example, only the storage device 20 is positioned in the cloud or that the control section 32 of the information processing device 10 and the storage device 20 are both positioned in the cloud.

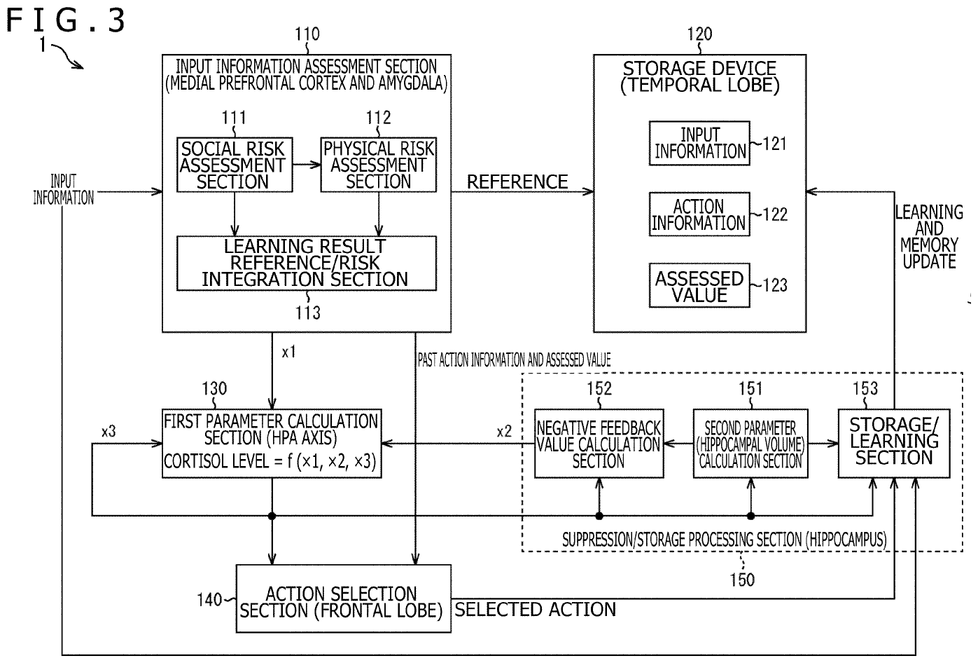

FIG. 3 is a block diagram illustrating an example of a functional configuration of the information processing system 1.

The information processing system 1 depicted in FIG. 3 includes an input information assessment section 110, a storage device 120, a first parameter calculation section 130, an action selection section 140, and a suppression/storage processing section 150.

Referring to FIG. 3, the input information assessment section 110, the first parameter calculation section 130, the action selection section 140, and the suppression/storage processing section 150 are implemented by the control section 32 depicted in FIG. 2. Further, referring to FIG. 3, the storage device 120 corresponds to the storage device 20 depicted in FIG. 2.

The input information assessment section 110 has functions corresponding to those of the medial prefrontal cortex and amygdala depicted in FIG. 1, and assesses the risk of the input information to the information processing system 1 (a possibility of damaging the information processing system 1) (the information processing system 1 may be hereinafter simply referred to as the system).

The input information assessment section 110 includes a social risk assessment section 111, a physical risk assessment section 112, and a learning result reference/risk integration section 113.

Based on the learning results stored in the storage device 120, the social risk assessment section 111 assesses the social risk that is imposed on the system by the input information from the input section 31. Here, the social risk represents the possibility of the system being bound, for example, by the evaluations of creditworthiness, influence, and performance of the system, by the social status of the system such as the capability of controlling the situation the system is in, and by applicable laws and regulations.

An assessed value indicating the social risk is supplied to the learning result reference/risk integration section 113.

Based on the learning results stored in the storage device 120, the physical risk assessment section 112 assesses the physical risk that is imposed on the system by the input information from the input section 31. Here, the physical risk represents, for example, the risk of coming into contact with something, the risk of suffering physical damage, or the risk of hurting people.

An assessed value indicating the physical risk is supplied to the learning result reference/risk integration section 113.

The learning result reference/risk integration section 113 integrates the assessed values from the social risk assessment section 111 and the physical risk assessment section 112 in order to calculate an assessed value ×1 representing an overall risk imposed on the information processing system 1 by the input information from the input section 31. Further, the learning result reference/risk integration section 113 references the learning results that are stored in the storage device 120 and associated with the input information from the input section 31.

As the past learning results, the storage device 120 stores input information 121, action information 122, and an assessed value 123.

The input information 121 is input information that is determined by past learning to be damaging to the system. The input information 121 includes information regarding risks that have been previously assessed on the input information.

Consequently, the social risk assessment section 111 and the physical risk assessment section 112 use the input information 121 to respectively assess the social risk and physical risk of the input information from the input section 31.

The action information 122 represents the result of action selection (approach) made by the system in response to the input information 121, which is obtained by past learning. It should be noted that there may be multiple pieces of action information (approaches) 122 with respect to the same input information 121.

The assessed value 123 is a value representing the assessment of an approach obtained by past learning and is associated with the action information 122. Based on an existing learning model, the assessed value of the approach is derived, for example, from the amount of decrease in a later-described first parameter (cortisol level) and the cost and time required for calculations and output processes.

Consequently, the learning result reference/risk integration section 113 references the action information 122 and the assessed value 123 with respect to the input information 121 identical with or similar to the input information from the input section 31, which are included in the learning results stored in the storage device 120.

The assessed value ×1 calculated by the learning result reference/risk integration section 113 is supplied to the first parameter calculation section 130. Further, past action information 122 and assessed value 123 referenced by the learning result reference/risk integration section 113 are supplied to the action selection section 140.

The first parameter calculation section 130 has a function applicable to the HPA axis depicted in FIG. 1, and calculates the first parameter, which represents the stress in the system, according to three input values ×1, ×2, and ×3. Here, the stress represents, for example, a situation where, in the course of machine learning, an action is not taken in a planned manner or a received reward is lower than expected. Stated differently, the first parameter is a system-specific internal variable equivalent to the cortisol level of the HPA axis. In the following description, the first parameter may be referred to also as the cortisol level.

The input value ×1 is the assessed value ×1 from the above-described input information assessment section 110. The input value ×2 is a negative feedback value ×2 that is calculated by the later-described suppression/storage processing section 150 and used to suppress the first parameter (cortisol level).

The calculated cortisol level is not only supplied to the action selection section 140 and the suppression/storage processing section 150, but also fed back as the input value ×3 to the first parameter calculation section 130.

The action selection section 140 has a function applicable to the frontal lobe depicted in FIG. 1, and selects a system action according to the cortisol level from the first parameter calculation section 130 and the past action information 122 and assessed value 123 from the input information assessment section 110. The result of system action selection (the selected action) and the associated input information are supplied to the suppression/storage processing section 150.

The suppression/storage processing section 150 has a function applicable to the hippocampus depicted in FIG. 1, suppresses the cortisol level calculated by the first parameter calculation section 130, and stores and learns the action selected by the action selection section 140.

The suppression/storage processing section 150 includes a second parameter calculation section 151, a negative feedback value calculation section 152, and a storage/learning section 153.

Based on the cortisol level from the first parameter calculation section 130, the second parameter calculation section 151 calculates a second parameter that decreases according to the amount and time of cortisol level input. The calculated second parameter is supplied to the negative feedback value calculation section 152 and the storage/learning section 153.

The second parameter is a system-specific internal variable equivalent to the hippocampal volume, which represents the volume of the hippocampus. In the following description, the second parameter may be referred to also as the hippocampal volume.

Based on the cortisol level from the first parameter calculation section 130 and the hippocampal volume from the second parameter calculation section 151, the negative feedback value calculation section 152 calculates the negative feedback value ×2 having a negative correlation with the cortisol level. The calculated negative feedback value ×2 is supplied to the first parameter calculation section 130.

Based on the cortisol level from the first parameter calculation section 130 and the hippocampal volume from the second parameter calculation section 151, the storage/learning section 153 not only learns the action selected by the action selection section 140, but also derives the assessed value of the selected action. The learning result and assessed value of the selected action are associated with the input information, and stored in the storage device 120 as the input information 121, the action information 122, and the assessed value 123.

### 3. FLOW OF LEARNING PROCESS

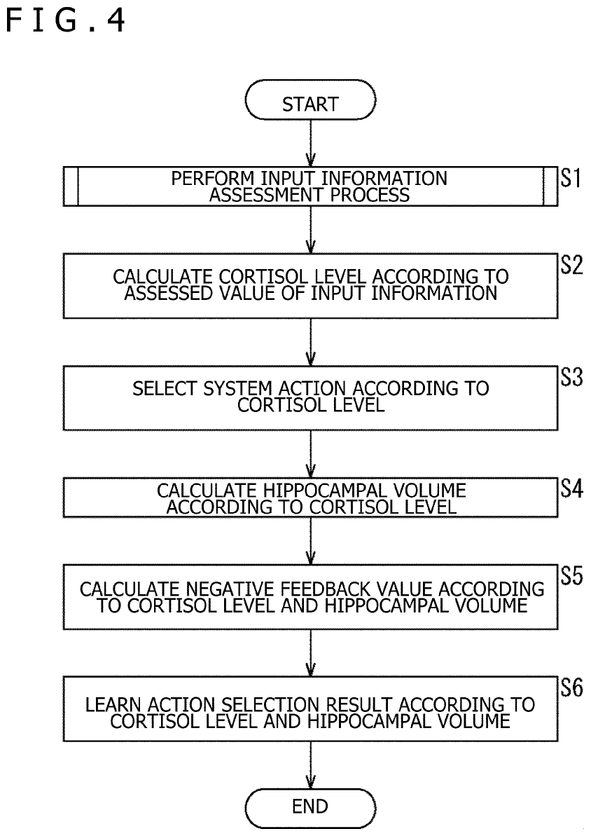

The flow of a learning process performed by the information processing system 1 depicted in FIG. 3 will now be described with reference to the flowchart of FIG. 4.

In step S1, the input information assessment section 110 performs an input information assessment process of assessing the risk of the input information to the information processing system 1.

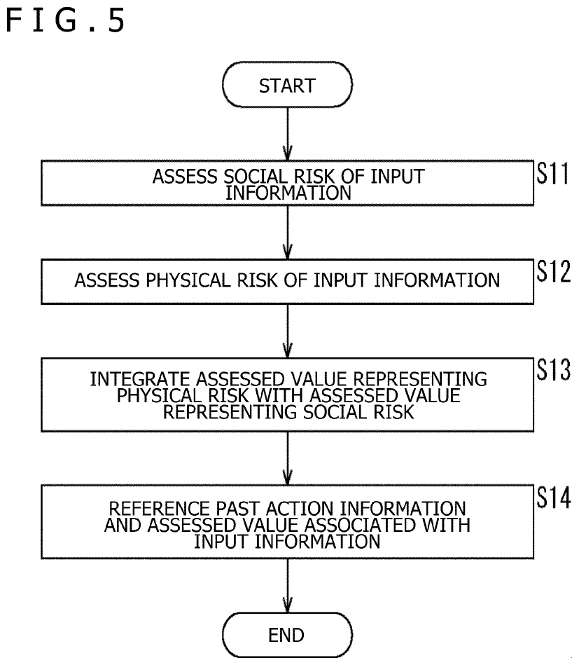

FIG. 5 is a flowchart illustrating the flow of the input information assessment process.

In step S11, based on the input information 121 stored in the storage device 120, the social risk assessment section 111 assesses the social risk of the input information from the input section 31 by using an existing learning model, and thus obtains the assessed value representing the social risk of the input information.

In step S12, based on the input information 121 stored in the storage device 120, the physical risk assessment section 112 assesses the physical risk of the input information from the input section 31 by using an existing learning model, and thus obtains the assessed value representing the physical risk of the input information.

Here, in the storage device 120, in a case where no existing input information 121 is identical with or similar to the input information from the input section 31, it is assessed that the social risk and physical risk of the input information are high.

In step S13, the learning result reference/risk integration section 113 obtains the assessed value ×1 representing the overall risk of the input information by integrating the assessed value representing the social risk of the input information with the assessed value representing the physical risk of the input information. The assessed value ×1 representing the overall risk of the input information is supplied to the first parameter calculation section 130.

In step S14, by using an existing learning model, the learning result reference/risk integration section 113 references, in the storage device 120, the past action information 122 and assessed value 123 with respect to the input information 121 identical with or similar to the input information from the input section 31. The referenced past action information 122 and assessed value 123 are supplied to the action selection section 140.

It should be noted that, in the storage device 120, in a case where no existing input information 121 is identical with or similar to the input information from the input section 31 (in a case where the action information 122 and assessed value 123 to be referenced do not exist), the action information 122 and assessed value 123 set as initial values may be referenced.

Returning to the flowchart of FIG. 4, in step S2, the first parameter calculation section 130 calculates the cortisol level (first parameter) according to the input information assessed value ×1, the negative feedback value ×2, and the previous cortisol level ×3.

The cortisol level f is calculated, for example, by a function that is expressed by f(×1, ×2, ×3)=a×1−b×2−c×3. Here, it is assumed that when coefficients a, b, c≥0, ×2, ×2, ×3≥0.

More specifically, the cortisol level has a positive correlation with the input information assessed value ×1, a negative correlation with the negative feedback value ×2, and a negative correlation with the previous cortisol level ×3. Stated differently, the input information from the external environment increases the cortisol level, and the feedback value, which loops within the system, decreases the cortisol level.

Alternatively, the cortisol level may be calculated according to the previous input values ×1, ×2, and ×3 so that the cortisol level changes with a time delay with respect to the input information (stress load), as is the case with the actual brain mechanism.

In step S3, the action selection section 140 selects a system action according to the cortisol level calculated by the first parameter calculation section 130.

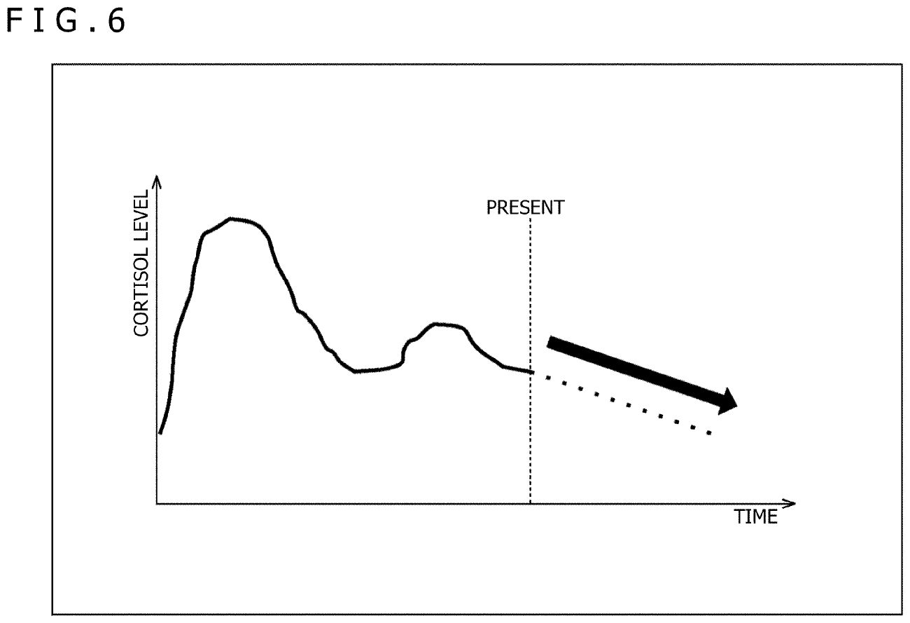

More specifically, the action selection section 140 regards some pieces of past action information 122 as candidates, and selects a system action according to the assessed values 123 of such pieces of past action information 122. In this instance, the action selection section 140 retains the cortisol level with respect to time (time series of cortisol levels), which is depicted, for example, in FIG. 6, and selects an action to decrease the cortisol level at and after the present time.

Further, the action selection section 140 selects a system action that is biased according to the cortisol level and its change tendency.

For example, in a case where the cortisol level is high (the amount of cortisol is large), an action to be selected is biased so as to decrease the cortisol level rapidly and greatly even when the system entails a high calculation cost. Meanwhile, in a case where the cortisol level is low (the amount of cortisol is small), the action to be selected is biased so as to decrease the cortisol level over a long period of time.

Further, in a case where the cortisol level has a tendency to change so as to increase with time, an action different from the previous one is selected. Meanwhile, in a case where the cortisol level has a tendency to change so as to decrease with time, an action selection is made to maintain the current action.

In the above instance, the action taken to decrease the cortisol level includes, for example, taking evasive action, taking measures against causes, and acting so as to obtain a different reward (taking a deceiving action).

It should be noted that, in a case where the input information from the input section 31 is brand new and no candidate past action information 122 exists, an alternative is to randomly select a system action, and eventually determine, based on subsequent changes in the cortisol level, whether or not the randomly selected system action is good.

Returning to the flowchart of FIG. 4, in step S4, the second parameter calculation section 151 calculates the hippocampal volume (second parameter) according to the cortisol level calculated by the first parameter calculation section 130.

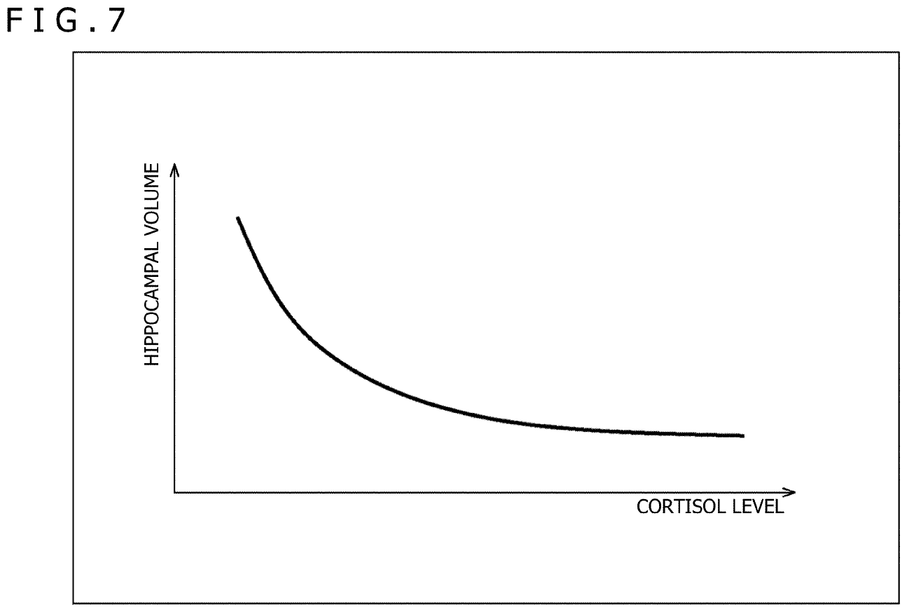

FIG. 7 is a diagram illustrating a relation between cortisol level and hippocampal volume.

As depicted in FIG. 7, the hippocampal volume monotonically decreases with time according to the cortisol level inputted to the second parameter calculation section 151. However, the relation depicted in FIG. 7 indicates that the hippocampal volume merely decreases with time. Therefore, in a case where the initial value of the hippocampal volume is set and the cortisol level is not higher than a predetermined threshold, the system may be actually configured to increase the hippocampal volume with time without exceeding the initial value.

As is the case with the actual brain mechanism, the hippocampal volume plays a role in adjusting the balance between cortisol suppression and storage/learning. More specifically, in a case where the hippocampal volume is high, it has not only the effect of increasing learning efficiency but also the effect of decreasing the cortisol level and thus decreasing the learning efficiency.

Returning to the flowchart of FIG. 4, in step S5, the negative feedback value calculation section 152 calculates the negative feedback value ×2, which suppresses the increase in the cortisol level, according to the cortisol level calculated by the first parameter calculation section 130 and the hippocampal volume calculated by the second parameter calculation section 151.

The negative feedback value ×2 has a positive correlation with the cortisol level and with the hippocampal volume.

In step S6, according to the cortisol level calculated by the first parameter calculation section 130 and the hippocampal volume calculated by the second parameter calculation section 151, the storage/learning section 153 learns the action selected by the action selection section 140.

Further, the storage/learning section 153 derives the assessed value indicating whether or not the stress associated with the input information is relieved by the selected action. More specifically, an existing learning model is used to derive the assessed value of the selected action, for example, from the amount of decrease in the cortisol level and the cost and time required for calculations and output processes, and then the selected action and the assessed value are stored in the storage device 120.

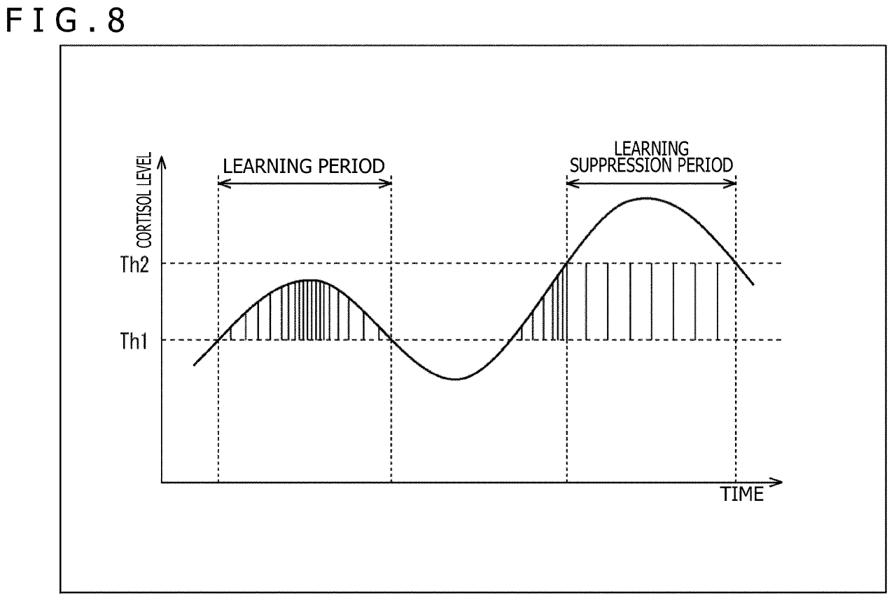

As depicted in FIG. 8, the storage/learning section 153 learns a relation between the input information and the selected action, which is used as an output, during a time interval (learning period) between a moment at which the cortisol level, which changes over time, increases to exceed a first threshold Th1 and a moment at which the cortisol level decreases below the first threshold Th1. Further, the storage/learning section 153 suppresses learning during the time interval (learning suppression period) between a moment at which the cortisol level increases above the first threshold Th1 and a moment at which the cortisol level remains above a second threshold that is greater than the first threshold Th1. In FIG. 8, the density of vertical lines attached to the curve indicating cortisol level changes represents the frequency and weight (magnitude) of learning and memory.

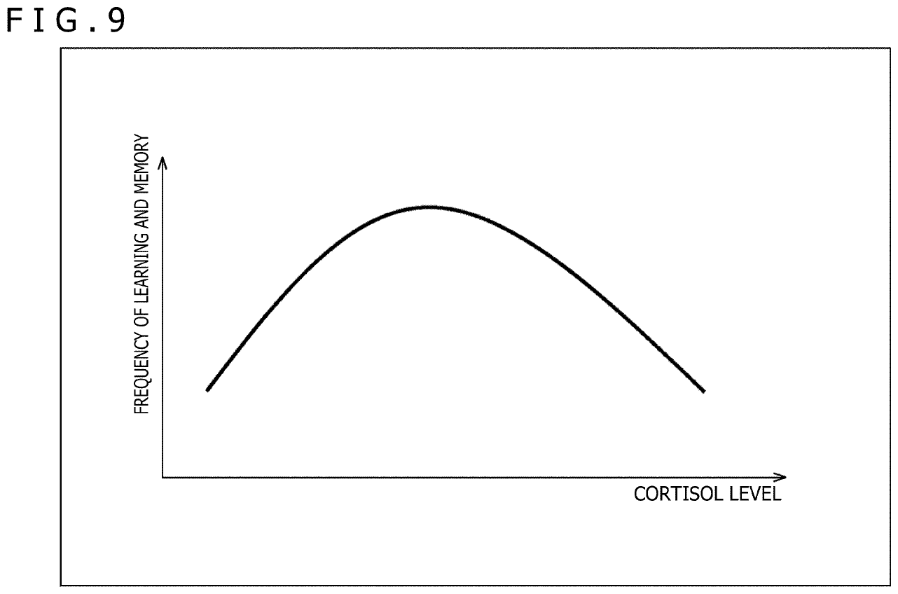

The storage/learning section 153 changes the frequency and weight of learning and memory, that is, the learning efficiency, according to the cortisol level and the hippocampal volume. The learning efficiency has a positive correlation with the hippocampal volume. Further, a relation of the frequency and weight of learning and memory (learning efficiency) to the cortisol level is represented by an upward projection curve as depicted in FIG. 9. According to FIG. 9, the learning efficiency is maximized when the cortisol level is high to a certain extent. That is, during the learning period, the storage/learning section 153 temporarily increases the learning efficiency and subsequently decreases the learning efficiency over time. During the learning period, the frequency and weight of learning and memory (learning efficiency) increase with the cortisol level.

As described above, the learning efficiency changes depending on whether the cortisol level and the hippocampal volume are high or low.

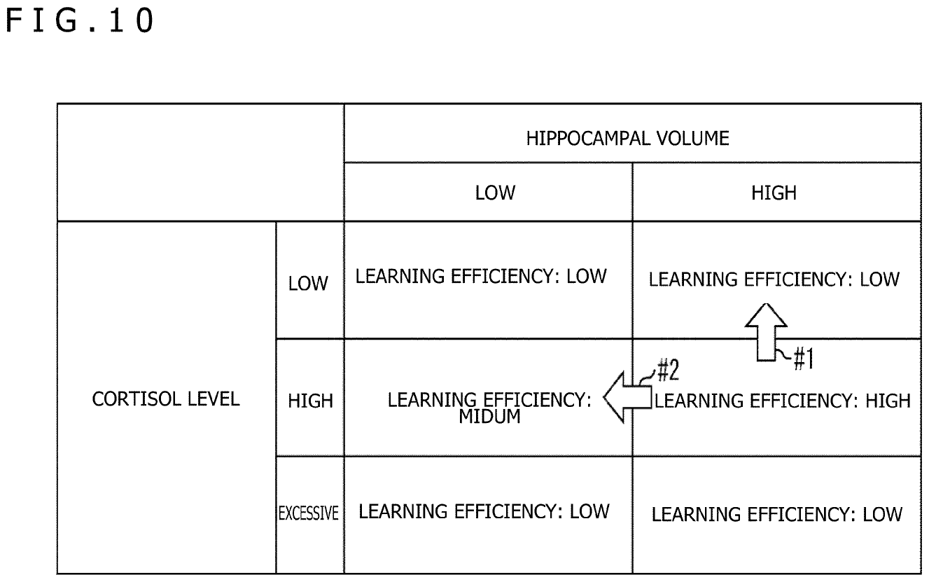

FIG. 10 is a diagram illustrating an example of learning efficiency with respect to cortisol level and hippocampal volume.

At an early stage where the system is at high risk (before the risk becomes excessive), it is highly probable that the cortisol level is higher (the amount of cortisol is larger) than a certain threshold, and that the hippocampal volume is also high. By increasing the learning efficiency in this state, the system is able to learn a variety of approaches and learn an action to be taken to perceive risks in advance and prevent them from becoming excessive. This makes it possible to take evasive action as if risks are perceived before they become excessive.

As described above, in a case where the risk rapidly decreases in a state where the learning efficiency is high, the cortisol level decreases below (the amount of cortisol becomes smaller than) a threshold while the hippocampal volume remains high, as indicated by an arrow #1 in FIG. 10. In this case, no more learning is required. Therefore, the system decreases the learning efficiency.

Further, in a case where the hippocampal volume is low and the cortisol level is lower (the amount of cortisol is smaller) than the threshold, the risk is low or a previously learned approach is working satisfactorily. In this case, no additional learning is required. Therefore, the system decreases the learning efficiency.

Furthermore, in a case where the risk does not easily decrease and is suppressed from increasing in a state where the learning efficiency is high, the hippocampal volume decreases while the cortisol level remains unchanged, as indicated by an arrow #2 in FIG. 10. In this case, the system performs learning at a medium learning efficiency level in order to slightly decrease the frequency and weight of learning and memory. This makes it possible to avoid excessive learning.

It should be noted that, in a case where the cortisol level is higher than a predetermined level (the second threshold depicted in FIG. 8), the risk is extremely high. In this case, action options available as a system output (action) are likely to be limited so the system is not allowed to move or react or is forced to repeatedly take the same action. Additionally, it is highly probable that an extreme situation is encountered in this case.

In the above case, the system is able to avoid excessive learning and an increase in calculation cost by decreasing the learning efficiency to suppress learning as described above.

According to the above-described configuration and processing, the information processing system 1 is able to perform learning adaptively to changes in the external environment and circumstances in response to the situation (stress) where, in the course of machine learning, an action is not taken in a planned manner or a received reward is lower than expected.

More specifically, the system is able to perform new learning irrespective of the past learning results by increasing the cortisol level (first parameter), which is an internal variable representing stress, and changing the learning efficiency according to the increased level, that is, the stress level.

Consequently, in response to the input information corresponding to previously learned action selection results, the system is able to perform learning again by increasing the cortisol level and thus select a new action. Further, in response to new input information, which has been not learned in the past, the system is able to perform new learning according to the cortisol level and select an appropriate action.

For example, the system is able to obtain negative learning results, which negate the past learning results, by performing learning weighted relative to the past learning results. In this instance, learning is performed in such a manner as to obtain learning results completely different from the past learning results instead of allowing the learning results to gradually change. This results in fine-tuning a learning model.

Further, when the system falls into local minima, the technology according to the present disclosure enables the system to escape from the local minima. In this case, in response to stress that occurs when the accuracy of learning remains below a certain level, learning is performed again based on the possibility that there exists a solution more optimal than the solution derived from the current learning results.

Furthermore, the technology according to the present disclosure enables the system to perform learning in such a manner as to include an extension of time and delay. In this case, the correspondence between certain environmental conditions and reward amounts is not directly learned. Instead, in the event of stress, such as damage or collision, learning is performed in such a manner as to include surroundings in time. Under circumstances where stress is caused, learning may be performed with the time scale and weight expanded.

As described above, in the system to which the technology according to the present disclosure is applied, the negative feedback value ×2, which suppresses the cortisol level, is inputted to the first parameter calculation section 130, which calculates the cortisol level (first parameter). This enables the system to prevent excessive learning by avoiding a situation where learning and memory are performed more than necessary.

Moreover, the system to which the technology according to the present disclosure is applied is configured to simulate the brain mechanism that reacts to actual stress, and is thus able to select an output similar to an actual human action. Therefore, when the technology according to the present disclosure is applied, for example, to a system configured to establish communication, such as a chatbot or a smart speaker for chatting, the system is able to provide more natural, lively interaction with humans.

### 4. APPLICATION EXAMPLES

The following describes application examples of the system to which the technology according to the present disclosure is applied.

### Application Example 1: Communication System

The system to which the technology according to the present disclosure is applied is applicable to a communication system.

The communication system is configured, for example, as a dialogue system or a sentence generation system. The dialogue system includes, for example, a chatting system such as a smart speaker or a dialogue AI, or an automated answering system of a call center. Further, the sentence generation system includes, for example, a chatbot, an article generation system, or a story generation system. Here, it is assumed that the output format of an action selected in the communication system is a text or a voice with no interaction.

In the communication system, it is assumed the input information is feedback information with respect to a text or a voice (dialogue) outputted by the communication system. The feedback information includes at least either voice information or text information.

It is assumed that the feedback information is, for example, the reaction of a user. The reaction of the user includes, for example, assessment information such as “Like” in an SNS (Social Networking Service), a questionnaire response, and a result of emotion estimation based on biological information regarding the user and analysis of user's facial expression.

Further, the feedback information may be a sales closing rate, a PV (Page View), other KPI (Key Performance Indicator), or the like representing an expected achievement of communication.

Subsequently, in the communication system, the input information assessment section 110 assesses, as the social risk, the degree of expectation with respect to the above-described feedback information. In a case where the degree of expectation is lower than anticipated, an increase occurs in the cortisol level, which represents stress.

The storage/learning section 153 learns the communication with the user and changes the learning efficiency according to the cortisol level. When the cortisol level increases, the storage/learning section 153 performs learning again or fine-tunes an existing learning model.

Communication, in particular, comes in and goes out of fashion depending on the culture and era. Dialogue and sentence generation based on an existing learning model may be inappropriate depending on region and time period.

For example, a sentence generated so as to satisfy the user may become unpopular, and buzzwords, popular sayings, and a sentence having specific nuances of meaning may become outdated over time. Further, due to social incidents, particular words and nuances may have discriminatory or negative connotations.

In view of the above problem, the communication system to which the technology according to the present disclosure is applied performs learning again or fine-tunes an existing learning model according to changes in region and time period. This makes it possible to generate appropriate dialogues and sentences according to changes in region and time period.

### Application Example 2: Complaint Handling System

The system to which the technology according to the present disclosure is applied is applicable to a complaint handling system that handles customer complaints.

In the complaint handling system, the storage/learning section 153 learns the method of handling the customer complaints.

Further, in the complaint handling system, it is assumed that the input information includes a customer complaint. The customer complaint includes at least any one of image information, voice information, and text information.

Subsequently, in the complaint handling system, the input information assessment section 110 assesses, as the social risk, the degree of difficulty in handling a customer or the complaint of the customer. More specifically, the input information assessment section 110 assesses the emotional state according to voice parameters, facial expression, and gesture of the customer. Further, the input information assessment section 110 not only assesses the emotional state according to words included in the result of voice recognition or text recognition, but also recognizes the contents of the complaint. Additionally, the input information assessment section 110 may assess the social status of the customer and a relation between the customer and the complaint handling system by determining, for example, whether or not the customer is an important customer or an influencer.

The action selection section 140 selects an action that is listed as one of complaint handling method candidates and is to be actually taken by the complaint handling system.

For example, in a case where the degree of difficulty in handling is low, it is highly probable that the degree of a customer's anger is low or that the contents of the complaint are the same as in the past. Therefore, the action selection section 140 selects the action, for example, of nodding affirmatively to the customer and suggesting a response.

Meanwhile, in a case where the degree of difficulty in handling is high, it is highly probable that the contents of the complaint are unprecedented. Therefore, the action selection section 140 selects the action, for example, of apologizing or remaining silent.

In a case where there is no appropriate complaint handling method, the action selection section 140 randomly selects, for example, a complaint handling method for similar complaints for the purpose of monitoring subsequent changes in the cortisol level.

Further, in a case where there are multiple appropriate complaint handling methods, the action selection section 140 allows a selected action to be biased according to the cortisol level. More specifically, in a case where the cortisol level is high (the amount of cortisol is large), the action selection section 140 makes an action selection so as, for example, to avoid an objection from the system because an increase in the degree of difficulty in handling is to be avoided. Meanwhile, in a case where the cortisol level is low (the amount of cortisol is small), the action selection section 140 makes the action selection so as, for example, to object against the complaint or make a suggestion from the system.

During the time interval between the start and end of complaint handling by the system, the storage/learning section 153 learns the contents of the complaint, the emotion of the customer, and the system's response to the complaint while the cortisol level is high. Learning progresses with respect to an unprecedented complaint because it increases the cortisol level. Further, in a case, for example, where the customer is extremely angry or the contents of the complaint do not make sense, the risk is extremely high, so that the cortisol level greatly increases. However, it is highly probable that the result of learning performed in such a situation is inapplicable to subsequent similar situations. In this case, therefore, learning stops progressing in order partly to avoid excessive learning.

### Application Example 3: Recommendation System

The system to which the technology according to the present disclosure is applied is applicable to a recommendation system that makes a recommendation to the user.

The recommendation system is configured as a system for recommending books, goods, or other products or as a system for recommending videos, music, or other content, in an EC (Electronic Commerce). Further, the recommendation system may be configured as a system for recommending persons or companies at a matching site or as a system for performing various searches.

In the recommendation system, it is assumed that the input information includes feedback information regarding a recommendation result (search result) outputted from the recommendation system. The feedback information includes at least any one of image information, voice information, and text information.

It is assumed that the feedback information represents user reaction and social reaction to the recommendation result (search result).

Subsequently, in the recommendation system, the input information assessment section 110 assesses, as the social risk, the degree of negativity of the feedback information described above. In a case where highly negative feedback information is obtained, an increase occurs in the cortisol level, which represents stress.

As regards the highly negative feedback information, the user and the society may react to an inappropriate recommendation presentation, such as an unlimited presentation of a product originally requiring parental control. Further, as regards the highly negative feedback information, the user and the society may react to a socially problematic presentation, such as the presentation of a human as the result of an animal image search or the biased presentation of specific content as the result of crime-related content recommendation.

The input information assessment section 110 may assess the degree of negativity of the feedback information inputted to the system or assess the degree of negativity of the feedback information obtained by crawling the Web. Further, the input information assessment section 110 may handle various sensing results of the user as the feedback information, and assess the degree of negativity of such sensing results.

The storage/learning section 153 learns the recommendation result obtained by the recommendation system, and changes the learning efficiency according to the cortisol level. When the highly negative feedback information is obtained to increase the cortisol level, the storage/learning section 153 performs learning again or fine-tunes an existing learning model. Consequently, when a subsequent recommendation/search is performed, a more appropriate recommendation result/search result can be presented.

### Application Example 4: Robot

The system to which the technology according to the present disclosure is applied is applicable to a robot.

Here, the robot is configured, for example, as a picking robot or an industrial robot. Further, the robot may be configured as a mobile robot, such as a guide robot, a baggage handling robot, an autonomous vehicle, or a drone.

In the robot, the storage/learning section 153 learns the action of the robot in a surrounding environment.

Further, it is assumed in the robot that the input information includes sensor information such as an image, a sound, a pressure, and a temperature.

Subsequently, in the robot, the input information assessment section 110 assesses, as the social risk, the possibility of the robot being damaged by the surrounding environment. More specifically, the input information assessment section 110 recognizes and identifies objects existing around the robot, and assesses the risk imposed by such objects. Further, the input information assessment section 110 assesses the amount of light and sound emitted from a target object. Additionally, in a case where the robot comes into contact with the target object, the input information assessment section 110 assesses the physical quantities of the target object, such as its pressure and temperature, estimates the distance to the target object, and assesses the possibility of collision. Moreover, in a case where the target object is a human or an animal, the input information assessment section 110 may estimate the emotions of the target object and make analysis to determine whether or not the robot is recognized by the target object.

The action selection section 140 selects the actual action to be taken by the robot from among candidate robot actions.

For example, in a case where there are a small number of objects around the robot and none of them is likely to damage the robot, the risk is low. In this case, therefore, the action selection section 140 makes an action selection so as to allow the robot to move freely.

In a case where a large number of objects exist around the robot and may possibly damage the robot, the risk is high. In this case, therefore, the action selection section 140 makes an action selection so as, for example, to change the course of the robot or stop the movement of the robot until the number of objects decreases. Further, in a case where the target object is a human or an animal, the action selection section 140 may make an action selection so as to notify the target object of the existence of the robot by emitting light or a sound.

In a case where there is no appropriate approach to avoid the risk, the action selection section 140 randomly selects an action so as to stop the movement of the robot, move the robot to a large space, or the like for the purpose of monitoring subsequent changes in the cortisol level.

Further, in a case where there are multiple appropriate approaches to avoid the risk, the action selection section 140 allows a selected action to be biased according to the cortisol level. More specifically, in a case where the cortisol level is high (the amount of cortisol is large), the action selection section 140 selects a complex action to communicate with the target object, for example, by notifying the target object of the existence of the robot by emitting light or a sound for the purpose of decreasing the risk as soon as possible. Meanwhile, in a case where the cortisol level is low (the amount of cortisol is small), it is sufficient if the risk decreases in the long run. In this case, therefore, the action selection section 140 selects a simple action so as to impose an insignificant burden on the surroundings, for example, by changing the movement speed of the robot.

The storage/learning section 153 learns surrounding target objects, their movement, and the system's response to them while the cortisol level is high. When an inexperienced situation or an unprecedented target object is encountered, the cortisol level increases. In such a case, therefore, learning progresses. Further, in a case where an extremely large number of surrounding target objects exist or the target objects move rapidly, the risk is extremely high, so that the cortisol level greatly increases. However, it is highly probable that the learning result obtained in such a peculiar situation is inapplicable to subsequent similar situations. In this case, therefore, learning refrains from progressing in order partly to avoid excessive learning.

When an event critical for the robot is encountered, the above-described configuration enables the robot to receive an input representing pre- and post-event conditions and perform learning so as to avoid risks.

For example, in a case where a person rushes out into the course of the robot and nearly collides with the robot, the robot learns that people may rush out to the relevant spot in the relevant time zone. Further, under additional conditions or under specific conditions, the robot learns safer evasive action.

Furthermore, not only the evasive action but also an action compliant with conditions may be selected as the action to be taken. For instance, the autonomous vehicle learns safety measures, that is, learns the capability, for example, of surely avoiding collisions by using high beams. Moreover, in a case where there is fog, the autonomous vehicle learns safety measures, that is, learns the capability of certainly avoiding collisions by honking a horn.

In the above examples, it is assumed that the input information assessment section 110 assesses the possibility of the robot being damaged by the surrounding environment. However, the input information assessment section 110 may additionally assess the risk that is imposed on the surrounding environment by the robot.

Consequently, robots and autonomous systems can be controlled in such a manner as to impose no stress on humans. For example, it is possible to automatically set, depending on the situation, the distance between a robot and a human and the speed at which the robot and the human approach each other. It is also possible to control, for example, an autonomous driving speed and cornering parameters.

Further, the technology according to the present disclosure makes it possible to provide a smooth interaction between robots and between AIs, make an ethical assessment and a value assessment based on stress imposed by the robots and AIs, and evaluate such assessments.

### 5. COMPUTER CONFIGURATION EXAMPLE

The above-described series of processes can be performed by hardware or by software. In a case where the series of processes is to be performed by software, programs included in the software are installed on a computer. Here, the computer may be a computer incorporated in dedicated hardware or may be a general-purpose personal computer or other computer capable of performing various functions as far as various programs are installed on the computer.

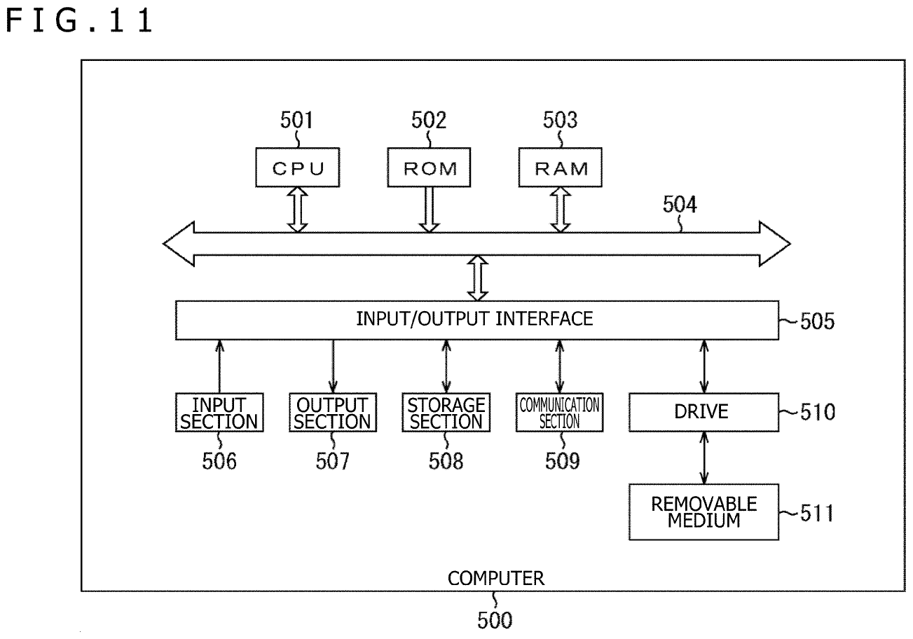

FIG. 11 is a block diagram illustrating an example hardware configuration of a computer that performs the above-described series of processes by executing the programs.

In a computer 500, a CPU (Central Processing Unit) 501, a ROM (Read Only Memory) 502, and a RAM (Random Access Memory) 503 are interconnected by a bus 504.

The bus 504 is further connected to an input/output interface 505. The input/output interface 505 is connected to an input section 506, an output section 507, a storage section 508, a communication section 509, and a drive 510.

The input section 506 includes, for example, a keyboard, a mouse, and a microphone. The output section 507 includes, for example, a display and a speaker. The storage section 508 includes, for example, a hard disk and a non-volatile memory. The communication section 509 includes, for example, a network interface. The drive 510 drives a removable medium 511 such as a magnetic disk, an optical disk, a magneto-optical disk, or a semiconductor memory.

In the computer 500 configured as described above, the CPU 501 performs the above-described series of processes, for example, by loading the programs stored in the storage section 508 into the RAM 503 through the input/output interface 505 and the bus 504, and executing the loaded programs.

The programs to be executed by the computer 500 (CPU 501) may be recorded and supplied, for example, on the removable medium 511, which is formed as a package medium. Further, the programs may be supplied through a wired or wireless transmission medium such as a local area network, the Internet, or a digital satellite broadcasting system.

The computer 500 is configured such that the programs can be installed in the storage section 508 through the input/output interface 505 when the removable medium 511 is inserted into the drive 510. Further, the programs can be received by the communication section 509 through a wired or wireless transmission medium and installed in the storage section 508. Furthermore, the programs can be pre-installed in the ROM 502 or the storage section 508.

It should be noted that the programs to be executed by the computer 500 may perform processing in a chronological order described in this document or perform processing in a parallel manner or at a required time point in response, for example, to a program call.

In this document, the steps describing the programs to be recorded in a recording medium not only include processes that are chronologically performed in a described order, but also include processes that are not always performed chronologically but performed in a parallel manner or on an individual basis.

The embodiment of the technology according to the present disclosure is not limited to the above-described embodiment, and can be variously modified without departing from the spirit and scope of the technology according to the present disclosure.

For example, the technology according to the present disclosure may be configured for cloud computing in which one function is shared by multiple devices through a network in order to perform processing in a collaborative manner.

Further, each step described with reference to the foregoing flowcharts can be not only performed by one device but also performed in a shared manner by multiple devices.

Furthermore, in a case where multiple processes are included in a single step, the multiple processes included in such a single step can be not only performed by one device but also performed in a shared manner by multiple devices.

Advantageous effects described in this document are merely illustrative and not restrictive. The present disclosure may additionally provide advantageous effects other than those described in this document.

Moreover, the technology according to the present disclosure may adopt the following configurations.

(1)

An information processing system including:
a learning section that learns results of action selection made by a system in response to input information;
an input information assessment section that assesses a risk of the input information to the system; and
a first parameter calculation section that calculates a first parameter representing stress on the system, according to an assessed value of the input information,
in which the learning section changes learning efficiency according to the first parameter.
   (2)

The information processing system according to (1),
in which the risk includes at least any one of a social risk and a physical risk that are imposed on the system.
   (3)

The information processing system according to (2), further including:
an action selection section that, based on a time series of the first parameter, selects an action of the system so as to decrease the first parameter.
   (4)

The information processing system according to (3),
in which the action selection section ensures that an action to be selected is biased according to the first parameter.
   (5)

The information processing system according to (3) or (4),
in which the action for decreasing the first parameter includes taking an evasive action, taking measures against causes, and acting so as to obtain a different reward.
   (6)

The information processing system according to any one of (1) to (5),
in which the learning section learns the action of the system during a time interval between a moment at which the first parameter increases above a first threshold and a moment at which the first parameter decreases below the first threshold.
   (7)

The information processing system according to (6),
in which, during the time interval, the learning section temporarily increases learning efficiency and subsequently decreases the learning efficiency over time.
   (8)

The information processing system according to (7),
in which the learning section increases a frequency and a weight of learning according to a magnitude of the first parameter during the time interval.
   (9)

The information processing system according to any one of (6) to (8),
in which the learning section suppresses the learning of the action of the system in a case where the first parameter increases above a second threshold, the second threshold being higher than the first threshold.
   (10)

The information processing system according to (3), further including:
a second parameter calculation section that calculates a second parameter, the second parameter decreasing according to an input amount of the first parameter,
in which the learning section increases a frequency and a weight of learning according to magnitudes of the first and second parameters.
   (11)

The information processing system according to (10), further including:
a feedback value calculation section that, according to the first and second parameters, calculates a feedback value having a negative correlation with the first parameter,
in which the first parameter calculation section calculates the first parameter according to the assessed value of the input information and the feedback value.
   (12)

The information processing system according to any one of (3) to (11), further including:
a storage device that stores results of learning of the action of the system,
in which the input information assessment section assesses the risk of the input information according to the results of learning that are stored in the storage device.
   (13)

The information processing system according to (12),
in which the action selection section selects the action of the system according to the results of learning that are referenced by the input information assessment section.
   (14)

The information processing system according to any one of (1) to (13),
in which the input information includes at least any one of sensor information, text information, and external information inputted from an external device or service, the sensor information including an image, a sound, a temperature, a pressure, and tactile sensation.
   (15)

The information processing system according to any one of (1) to (14),
in which the information processing system is configured as a communication system,
the learning section learns communications with a user, and
the input information assessment section assesses a degree of expectation for feedback information with respect to a text or a voice outputted by the communication system.
   (16)

The information processing system according to any one of (1) to (14),
in which the information processing system is configured as a complaint handling system that handles complaints of a customer,
the learning section learns a method of handling the complaints, and
the input information assessment section assesses a degree of difficulty in handling the customer or the complaints.
   (17)

The information processing system according to any one of (1) to (14),
in which the information processing system is configured as a recommendation system that makes a recommendation to a user,
the learning section learns results of recommendation made by the recommendation system, and
the input information assessment section assesses a degree of negativity of feedback information with respect to the results of recommendation.
   (18)

The information processing system according to any one of (1) to (14),
in which the information processing system is configured as a robot,
the learning section learns an action of the robot in a surrounding environment, and
the input information assessment section assesses a possibility of the robot being damaged by the surrounding environment.
   (19)

An information processing method that is adopted by an information processing system, the information processing method including:
learning results of action selection made by a system in response to input information;
assessing a risk of the input information to the system;
calculating a first parameter representing stress on the system according to an assessed value of the input information; and
changing learning efficiency according to the first parameter.
   (20)

An information processing device including:
a learning section that learns results of action selection made by a system in response to input information;
an input information assessment section that assesses a risk of the input information to the system; and
a first parameter calculation section that calculates a first parameter representing stress on the system, according to an assessed value of the input information,
in which the learning section changes learning efficiency according to the first parameter.

### REFERENCE SIGNS LIST

1: Information processing system
10: Information processing device
20: Storage device
31: Input section
32: Control section
33: Output section
110: Input information assessment section
111: Social risk assessment section
112: Physical risk assessment section
113: Learning result reference/risk integration section
120: Storage device
130: First parameter calculation section
140: Action selection section
150: Suppression/storage processing section
151: Second parameter calculation section
152: Negative feedback value calculation section
153: Storage/learning section
500: Computer
501: CPU

1. An information processing system comprising:
a learning section that learns results of action selection made by a system in response to input information;
an input information assessment section that assesses a risk of the input information to the system; and
a first parameter calculation section that calculates a first parameter representing stress on the system, according to an assessed value of the input information,
wherein the learning section changes learning efficiency according to the first parameter.

2. The information processing system according to claim 1,
wherein the risk includes at least any one of a social risk and a physical risk that are imposed on the system.

3. The information processing system according to claim 2, further comprising:
an action selection section that, based on a time series of the first parameter, selects an action of the system so as to decrease the first parameter.

4. The information processing system according to claim 3,
wherein the action selection section ensures that an action to be selected is biased according to the first parameter.

5. The information processing system according to claim 3,
wherein the action for decreasing the first parameter includes taking an evasive action, taking measures against causes, and acting so as to obtain a different reward.

6. The information processing system according to claim 1,
wherein the learning section learns the action of the system during a time interval between a moment at which the first parameter increases above a first threshold and a moment at which the first parameter decreases below the first threshold.

7. The information processing system according to claim 6,
wherein, during the time interval, the learning section temporarily increases learning efficiency and subsequently decreases the learning efficiency over time.

8. The information processing system according to claim 7,
wherein the learning section increases a frequency and a weight of learning according to a magnitude of the first parameter during the time interval.

9. The information processing system according to claim 6,
wherein the learning section suppresses the learning of the action of the system in a case where the first parameter increases above a second threshold, the second threshold being higher than the first threshold.

10. The information processing system according to claim 3, further comprising:
a second parameter calculation section that calculates a second parameter, the second parameter decreasing according to an input amount of the first parameter,
wherein the learning section increases a frequency and a weight of learning according to magnitudes of the first and second parameters.

11. The information processing system according to claim 10, further comprising:
a feedback value calculation section that, according to the first and second parameters, calculates a feedback value having a negative correlation with the first parameter,
wherein the first parameter calculation section calculates the first parameter according to the assessed value of the input information and the feedback value.

12. The information processing system according to claim 3, further comprising:
a storage device that stores results of learning of the action of the system,
wherein the input information assessment section assesses the risk of the input information according to the results of learning that are stored in the storage device.

13. The information processing system according to claim 12,
wherein the action selection section selects the action of the system according to the results of learning that are referenced by the input information assessment section.

14. The information processing system according to claim 1,
wherein the input information includes at least any one of sensor information, text information, and external information inputted from an external device or service, the sensor information including an image, a sound, a temperature, a pressure, and tactile sensation.

15. The information processing system according to claim 1,
wherein the information processing system is configured as a communication system,
the learning section learns communications with a user, and
the input information assessment section assesses a degree of expectation for feedback information with respect to a text or a voice outputted by the communication system.

16. The information processing system according to claim 1,
wherein the information processing system is configured as a complaint handling system that handles complaints of a customer,
the learning section learns a method of handling the complaints, and
the input information assessment section assesses a degree of difficulty in handling the customer or the complaints.

17. The information processing system according to claim 1,
wherein the information processing system is configured as a recommendation system that makes a recommendation to a user,
the learning section learns results of recommendation made by the recommendation system, and
the input information assessment section assesses a degree of negativity of feedback information with respect to the results of recommendation.

18. The information processing system according to claim 1,
wherein the information processing system is configured as a robot,
the learning section learns an action of the robot in a surrounding environment, and
the input information assessment section assesses a possibility of the robot being damaged by the surrounding environment.

19. An information processing method that is adopted by an information processing system, the information processing method comprising:
learning results of action selection made by a system in response to input information;
assessing a risk of the input information to the system;
calculating a first parameter representing stress on the system according to an assessed value of the input information; and
changing learning efficiency according to the first parameter.

20. An information processing device comprising:
a learning section that learns results of action selection made by a system in response to input information;
an input information assessment section that assesses a risk of the input information to the system; and
a first parameter calculation section that calculates a first parameter representing stress on the system, according to an assessed value of the input information,
wherein the learning section changes learning efficiency according to the first parameter.
